(19) United States
(12) Patent Application Publication
(10) Pub. No.: US 2014/0184508 A1
(43) Pub. Date: Jul. 3, 2014

(54) UNIVERSAL ADAPTIVE GAME CONTROLLER

(71) Applicant: NVIDIA CORPORATION, Santa Clara, CA (US)

(72) Inventors: Anthony Michael Tamasi, Los Gatos, CA (US); Jensen Huang, Los Altos Hills, CA (US); Ashutosh Gajanan Rege, San Francisco, CA (US)

(73) Assignee: NVIDIA CORPORATION, Santa Clara, CA (US)

(21) Appl. No.: 13/728,528

(22) Filed: Dec. 27, 2012

(51) Int. Cl. G06F 3/033

(52) U.S. Cl. CPC G06F 3/033
USPC 345/161

(57) ABSTRACT

One or more embodiments of the present invention may include a body comprising a user interface, wherein the user interface is operable to be configured for a first interactive media device and a second interactive media device. The one or more embodiments may further include memory operable to store a plurality of user interface configurations, wherein a first user interface configuration corresponds to the first interactive media device and the second interactive media device, and wherein the memory is further operable to store a software application state. The one or more embodiments may additionally include a communication interface operable to communicatively couple with the first interactive media device and the second interactive media device, wherein the communication interface is operable to send user inputs from the user interface to the first interactive media device and the second interactive media device.

### BACKGROUND OF THE INVENTION

Conventionally, an application such as a video game is executed (played) using a personal computer (PC) or a gaming console connected to a television. A user purchases or rents a game that is loaded onto the PC or console and then played in a well-known manner. For example, in the case of a gaming console, a user may interact with the video game through a game controller belonging to the console and that is connected to the console through a wired or wireless interface. In the case of a PC, a user may interact with the video game through a keyboard, mouse, and/or other peripherals like a joystick.

More recently, mobile gaming has become popular. For example, a mobile phone may provide a video game to a user that can be controlled through, for example, the touchscreen controls of the mobile phone. In another example, other mobile devices like tablets may provide video games to users and can be controlled in similar ways.

Some video games can be played on various devices, platforms, and/or operating systems. For example, a specific game may be provided for gaming consoles provided by competing manufacturers. Further, the same game may be playable on a PC or a mobile device. Conventionally, a user could play the same game on various devices, but because each device provides a different interface and other options, a user's game play experience may vary considerably between different devices. For example, each device may be playable with device-specific controls that the user must adapt to. Further, it may be difficult or impossible to resume playing a game one a new device with similar settings as were provided on a previous device.

### BRIEF SUMMARY OF THE INVENTION

Accordingly, embodiments of the invention are directed to methods and systems for providing a game controller that is operable to control various devices, including gaming consoles, PCs, and mobile devices. The controller may pair with various devices and communicate with each device using device-specific protocols through a wired or wireless interface. Accordingly, the game controller may control the various devices similarly to the way in which the conventionally device-specific controllers do so.

In various embodiments of the invention, the controller may access user profile information to provide a seamless experience to a user when a user switches from using the controller on one device to another. For example, the controller may save different button configurations for each device according to a user's preferences. In some cases, the controller may substantially harmonize the button configuration between different devices such that the same button will behave similarly on different devices. Accordingly, the user may not need to learn or become comfortable with various controllers for different devices. In another example, the controller may save a game state, for example, a map checkpoint or player health statistics. When using the controller on a different gaming device, the controller may provide the saved game state so that the gaming devices may resume game play from where the user left off.

One or more embodiments of the present invention may include a body comprising a user interface, wherein the user interface is operable to be configured for a first interactive media device and a second interactive media device. The one or more embodiments may further include memory operable to store a plurality of user interface configurations, wherein a first user interface configuration corresponds to the first interactive media device and the second interactive media device, and wherein the memory is further operable to store a software application state. The one or more embodiments may additionally include a communication interface operable to communicatively couple with the first interactive media device and the second interactive media device, wherein the communication interface is operable to send user inputs from the user interface to the first interactive media device and the second interactive media device.

One or more embodiments of the present invention may include receiving a first user interface configuration from a plurality of user configurations, wherein the user interface configuration corresponds to a first interactive media device and a first instance of a software application. The one or more embodiments may further include storing the user interface configuration. Upon communicatively coupling with a second interactive media device, the one or more embodiments may additionally include reconfiguring a user interface from a second user interface configuration based on the first user interface configuration corresponding to the first interactive media device and the first instance of the software application.

One or more embodiments of the present invention may include receiving first a software application state from a first interactive media device. The one or more embodiments may further include storing the software application state. Upon communicatively coupling with a second interactive media device, the one or more embodiments may additionally include sending the software application state to the second interactive media device for restoring an instance of the software application executing on the second interactive media device to a restored state corresponding to the software application state.

The following detailed description together with the accompanying drawings will provide a better understanding of the nature and advantages of the present invention.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 is a block diagram of an example of a computing system capable of implementing embodiments of the present disclosure.

FIG. 2 is a block diagram of an example of a network architecture in which client systems and servers may be coupled to a network, according to embodiments of the present invention.

FIG. 3 is a front-side illustration of an exemplary universal adaptive game controller, according to an embodiment of the present invention.

FIG. 4 is a back-side illustration of the exemplary universal adaptive game controller, according to an embodiment of the present invention.

FIG. 5 is an illustration of the exemplary universal adaptive game controller coupled with a mobile device, according to an embodiment of the present invention.

FIG. 6 is an illustration of an exemplary universal adaptive game controller with a display, according to an embodiment of the present invention.

FIG. 7 is block diagram of an exemplary universal adaptive game controller in communication with at least one device, according to an embodiment of the present invention.

FIG. 8 depicts a flowchart of an exemplary process of using a universal adaptive game controller, according to an embodiment of the present invention.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

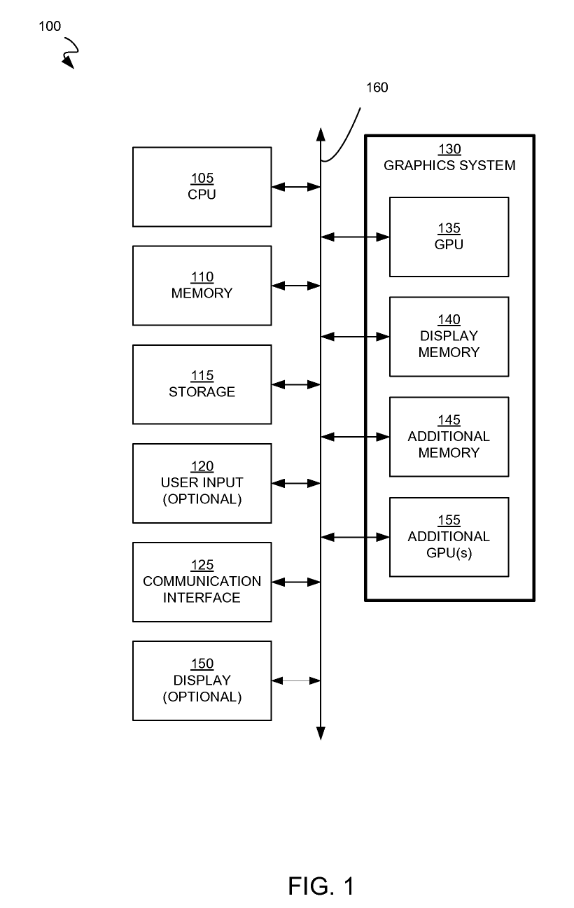

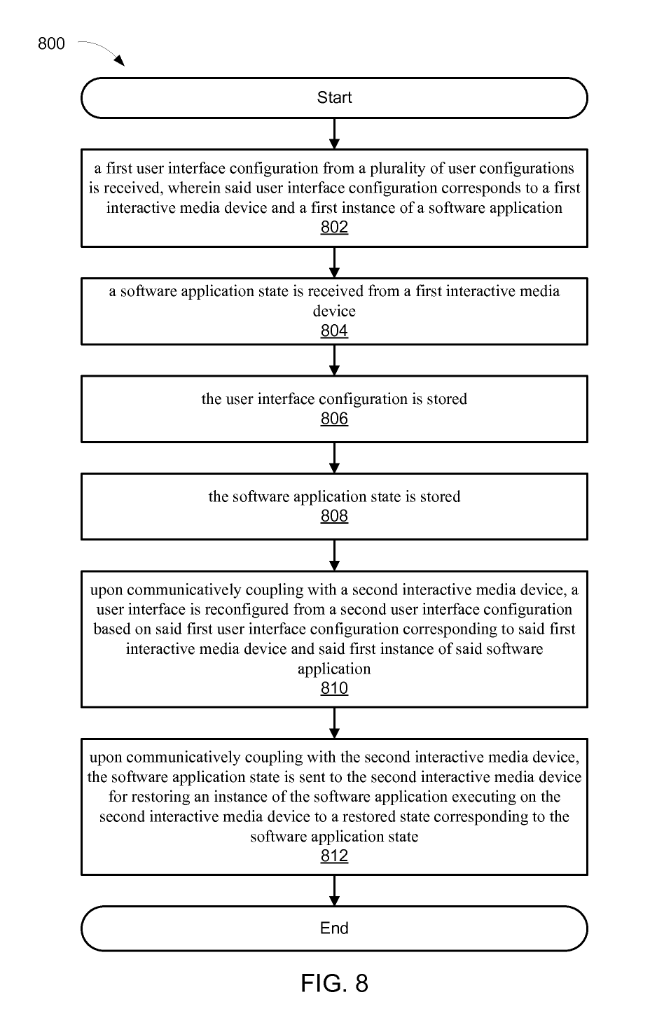

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “generating,” “sending,” “decoding,” “encoding,” “accessing,” “streaming,” or the like, refer to actions and processes (e.g., flowchart 800 of FIG. 8) of a computer system or similar electronic computing device or processor (e.g., system 100 of FIG. 1). The computer system or similar electronic computing device manipulates and transforms data represented as physical (electronic) quantities within the computer system memories, registers or other such information storage, transmission or display devices.

For expository purposes, the term “horizontal” as used herein refers to a plane parallel to the plane or surface of an object, regardless of its orientation. The term “vertical” refers to a direction perpendicular to the horizontal as just defined. Terms such as “above,” “below,” “bottom,” “top,” “side,” “higher,” “lower,” “upper,” “over,” and “under” are referred to with respect to the horizontal plane.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1 is a block diagram of an example of a computer system 100 capable of implementing embodiments according to the present invention. In the example of FIG. 1, the computer system 100 includes a central processing unit (CPU) 105 for running software applications and optionally an operating system. Memory 110 stores applications and data for use by the CPU 105. Storage 115 provides non-volatile storage for applications and data and may include fixed disk drives, removable disk drives, flash memory devices, and CD-ROM, DVD-ROM or other optical storage devices. The optional user input 120 includes devices that communicate user inputs from one or more users to the computer system 100 and may include keyboards, mice, joysticks, touch screens, and/or microphones.

The communication or network interface 125 allows the computer system 100 to communicate with other computer systems via an electronic communications network, including wired and/or wireless communication and including the Internet. The optional display device 150 may be any device capable of displaying visual information in response to a signal from the computer system 100. The components of the computer system 100, including the CPU 105, memory 110, data storage 115, user input devices 120, communication interface 125, and the display device 150, may be coupled via one or more data buses 160.

In the embodiment of FIG. 1, a graphics system 130 may be coupled with the data bus 160 and the components of the computer system 100. The graphics system 130 may include a physical graphics processing unit (GPU) 135 and graphics memory. The GPU 135 generates pixel data for output images from rendering commands. The physical GPU 135 can be configured as multiple virtual GPUs that may be used in parallel (concurrently) by a number of applications executing in parallel.

Graphics memory may include a display memory 140 (e.g., a framebuffer) used for storing pixel data for each pixel of an output image. In another embodiment, the display memory 140 and/or additional memory 145 may be part of the memory 110 and may be shared with the CPU 105. Alternatively, the display memory 140 and/or additional memory 145 can be one or more separate memories provided for the exclusive use of the graphics system 130.

In another embodiment, graphics processing system 130 includes one or more additional physical GPUs 155, similar to the GPU 135. Each additional GPU 155 may be adapted to operate in parallel with the GPU 135. Each additional GPU 155 generates pixel data for output images from rendering commands. Each additional physical GPU 155 can be configured as multiple virtual GPUs that may be used in parallel (concurrently) by a number of applications executing in parallel. Each additional GPU 155 can operate in conjunction with the GPU 135 to simultaneously generate pixel data for different portions of an output image, or to simultaneously generate pixel data for different output images.

Each additional GPU 155 can be located on the same circuit board as the GPU 135, sharing a connection with the GPU 135 to the data bus 160, or each additional GPU 155 can be located on another circuit board separately coupled with the data bus 160. Each additional GPU 155 can also be integrated into the same module or chip package as the GPU 135. Each additional GPU 155 can have additional memory, similar to the display memory 140 and additional memory 145, or can share the memories 140 and 145 with the GPU 135.

For example, a computer program for configuring a user interface or sending a software application state may be stored on the computer-readable medium and then stored in system memory 116 and/or various portions of storage devices 132 and 133. When executed by the processor 114, the computer program may cause the processor 114 to perform and/or be a means for performing the functions required for carrying out the configuring or sending processes discussed above.

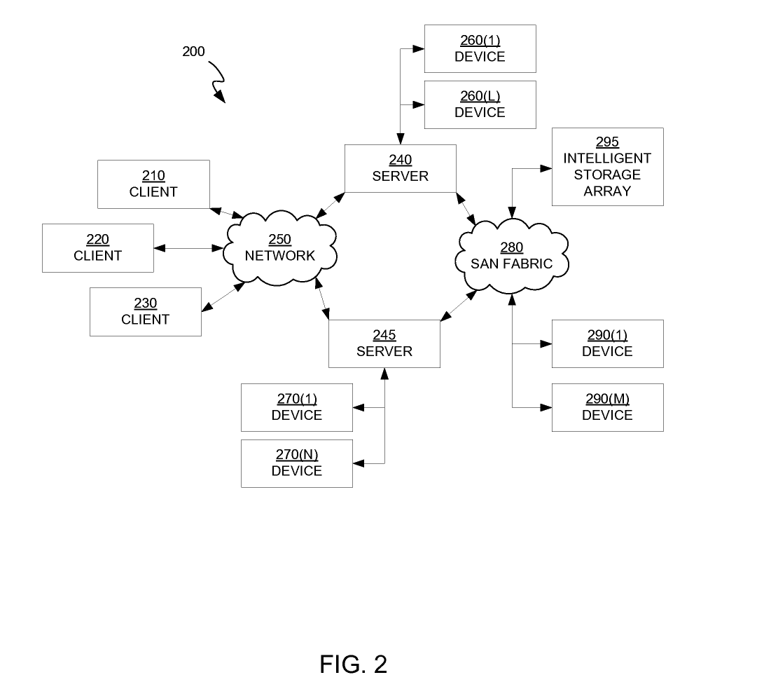

FIG. 2 is a block diagram of an example of a network architecture 200 in which client systems 210, 220, and 230 and servers 240 and 245 may be coupled to a network 250. Client systems 210, 220, and 230 generally represent any type or form of computing device or system, such as computing system 110 of FIG. 1.

Similarly, servers 240 and 245 generally represent computing devices or systems, such as application servers or database servers, configured to provide various database services and/or run certain software applications. Network 250 generally represents any telecommunication or computer network including, for example, an intranet, a wide area network (WAN), a local area network (LAN), a personal area network (PAN), or the Internet.

With reference to computing system 110 of FIG. 1, a communication interface, such as communication interface 122, may be used to provide connectivity between each client system 210, 220, and 230 and network 250. Client systems 210, 220, and 230 may be able to access information on server 240 or 245 using, for example, a Web browser or other client software. Such software may allow client systems 210, 220, and 230 to access data hosted by server 240, server 245, storage devices 260(1)-(L), storage devices 270(1)-(N), storage devices 290(1)-(M), or intelligent storage array 295. Although FIG. 2 depicts the use of a network (such as the Internet) for exchanging data, the embodiments described herein are not limited to the Internet or any particular network-based environment.

In one embodiment, all or a portion of one or more of the example embodiments disclosed herein are encoded as a computer program and loaded onto and executed by server 240, server 245, storage devices 260(1)-(L), storage devices 270(1)-(N), storage devices 290(1)-(M), intelligent storage array 295, or any combination thereof. All or a portion of one or more of the example embodiments disclosed herein may also be encoded as a computer program, stored in server 240, run by server 245, and distributed to client systems 210, 220, and 230 over network 250.

Universal Adaptive Game Controller

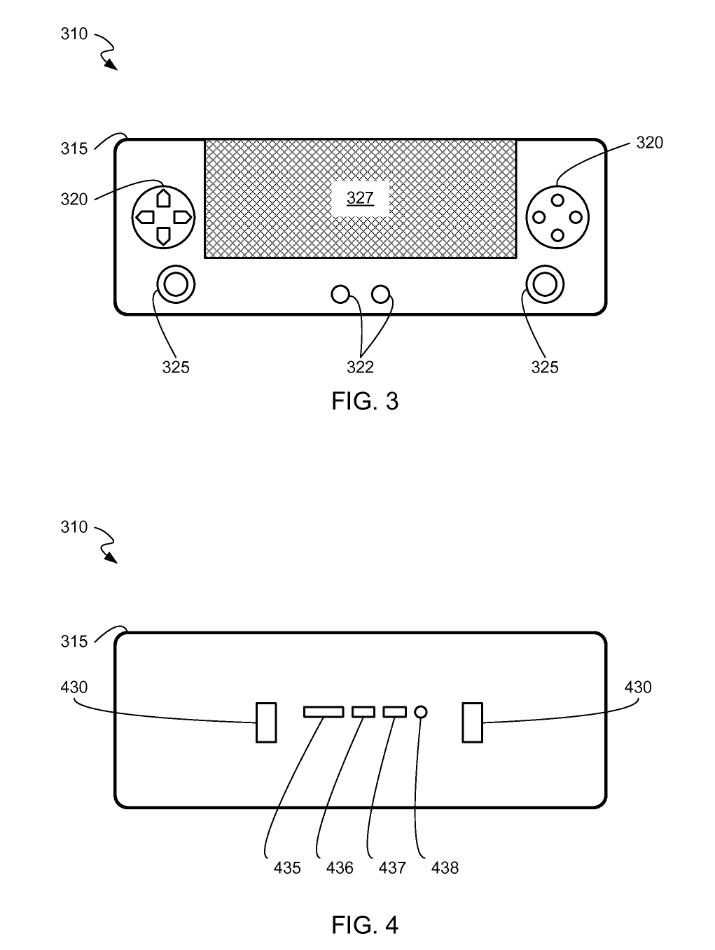

FIG. 3 is a front-side illustration of an exemplary universal adaptive game controller 310, according to an embodiment of the present invention. The gaming console 310 may include a controller body 315 that may include a device docking area 327. As discussed below, the device docking area 327 may be able to secure, for example, a mobile phone.

The adaptive game controller 310 may be similar to the computer system 100 of FIG. 1. For example, the adaptive game controller 310 may include a CPU or processor, memory, storage, graphics system, communication interface, and so on. Further, the adaptive game controller 310 may include additional components like an audio processing system or other components as discussed below. These components may be partially or fully coupled with one another in different configurations through, for example, a data bus.

As discussed above, the adaptive game controller 310 may run at least one operating system and/or software application. The software application may be operable to store information related to interactive media, for example, a player's button configuration preferences, profile in a game, or game state. Such information may be stored locally on the adaptive game controller 310, or remotely through a cloud-based computing system. Cloud computing is the use of computing resources (hardware and software) that are delivered as a service over a network (typically the Internet). Further, the software application may provide a device pairing process.

The controller body 315 may include a user interface. The user interface may include physically manipulatable controls including but not limited to directional pads (D-pads) or joysticks 325, individual buttons 322, and button groups 320 with various buttons. As a result, a user may hold the adaptive game controller 310 and interact with the software application, for example a video game, movie, web browser, and so on, by using the physically manipulatable controls.

The adaptive game controller 310 may include one or more communication interface components. For example, the adaptive game controller 310 may include a wired communication interface for communicating with a gaming console. In another example, the adaptive game controller 310 may include a wireless network adapter operable to communicate with a wireless access point (e.g., a wireless router) and ultimately communicate with further networks (e.g., the Internet). Alternatively or in addition, the adaptive game controller 310 may include a Bluetooth adapter operable to communicate with other Bluetooth devices.

In some embodiments, the adaptive game controller 310 may include a cellular network adapter operable to communicate over a cellular network. As a result, when the adaptive game controller 310 is within the range of a wireless network, it may connect to the wireless network or the cellular network. When the adaptive game controller 310 is outside the range of a wireless network, it may connect to the cellular network to continue receiving network access.

The adaptive game controller 310 may include an environmental motion-tracking component that may include a camera. The environmental motion-tracking component may track movement in the surrounding environment, for example the movement of a user's body, and provide information associated with the tracked movement to the adaptive game controller 310. As a result, the adaptive game controller 310 may be controlled based in part on motions or movement of a user.

The adaptive game controller 310 may include an internal motion-tracking component that may include a gyroscopic sensor, accelerometer sensor, or the like. The adaptive game controller 310 may also include an electronic compass sensor. The internal motion-tracking component may track movement of the adaptive game controller 310, for example by movements made by a user, and provide information associated with the tracked movement to the adaptive game controller 310. As a result, the adaptive game controller 310 may be controlled based in part on the motion of the adaptive game controller 310.

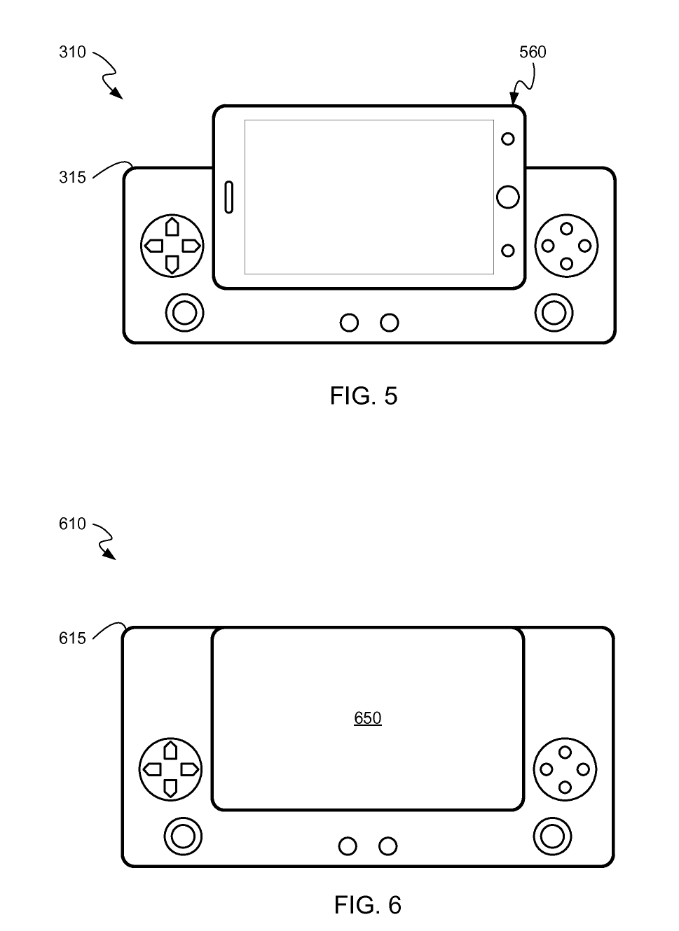

The adaptive game controller 310 may include batteries that provide power. The batteries may be rechargeable batteries. Further, the batteries or the adaptive game controller 310 may be recharged or receive power through inductive power transfer, respectively. Further, the adaptive game controller 310 may provide power to a device that may be docked or proximate to the device docking area 327 (discussed with respect to FIG. 5) through inductive power transfer. Alternatively, or in addition, the adaptive game controller 310 may be operable to connect to a power outlet to be directly powered or to recharge rechargeable batteries.

The adaptive game controller 310 may include a force feedback vibration component. The force feedback vibration component may cause the adaptive game controller 310 to vibrate in response to events of a software application. For example, the force feedback vibration component may vibrate when a character shoots a weapon or takes on damage in a video game.

FIG. 4 is a back-side illustration of the exemplary universal adaptive game controller 310, according to an embodiment of the present invention. The view shown in FIG. 4 may be a backside view of the adaptive game controller 310 of FIG. 3. The adaptive game controller 310 may include various communication ports. For example, the adaptive game controller 310 may include a removable storage port 435, a bus port 436, an external display port 437, and/or an audio port 438.

The removable storage port 435 may be operable to connect with storage media like an SD card or CompactFlash. Such media may store information stored by a game, for example, checkpoints or user profiles. Such media may store information like movies, music, and photos. The bus port 436 may allow the adaptive game controller 310 to connect with other devices. The bus port 436 may be a USB port, FireWire port, Ethernet port, and so on. The bus port 436 may allow connection to USB thumb drives or USB external drives for read/write access to additional storage.

The external display port 437 may allow the adaptive game controller 310 to connect with external displays. The external display port 437 may be an HDMI port, Thunderbolt port, or the like. The audio port 438 may be operable to provide audio generated by the adaptive game controller 310. For example, the audio port 438 may be a mini jack port, micro jack port, TOSLINK port, or the like. Accordingly, a user may connect a sound system or headset to the audio port 438.

The adaptive game controller 310 may include built-in speakers that are operable to play audio associated with the software application or operating system running one the adaptive game controller 310. Alternatively, the adaptive game controller 310 may include a Bluetooth component. In addition to being capable of connecting with various devices, the Bluetooth component may be operable to send and receive audio wirelessly.

It should be noted that the physically manipulatable controls, ports, and other components of the adaptive game controller 310 are not limited to being either on a front or backside of the adaptive game controller 310 or the controller body 315. For example, some or all ports may be included on the front side of controller body 315. Or, for example, the adaptive game controller 310 may include backside buttons 430.

The physically manipulatable controls, ports, and other components of the adaptive game controller 310 are not limited to being either on a front or backside of the adaptive game controller 310 or the controller body 315. For example, the adaptive game controller 310 may include backside buttons 430.

FIG. 5 is an illustration of the exemplary universal adaptive game controller 310 coupled with a mobile device 560, according to an embodiment of the present invention. The mobile device 560 may dock with the universal adaptive game controller 310 through the device docking area 327 (shown in FIG. 3 but not shown in FIG. 5). The controller body 315 and/or the device docking area 327 may be adjustable in order to accommodate different sizes of mobile devices. The docking area 327 may be operable to secure mobile devices so that such devices are prevented from disconnecting until a user intends to disconnect such a device.

The mobile device 560 may be a mobile phone, a tablet, a mobile gaming console, or any other device capable of providing an interactive media experience. The universal adaptive game controller 310 may be operable to communicate with the mobile device 560, for example, through Bluetooth, IEEE 802.11, or a wired interface. Accordingly, the adaptive game controller 310 and mobile device 560 may exchange data including, audio, video, user interface commands, and so on. For example, the mobile device 560 may receive data corresponding to user inputs through the physically manipulatable controls of the adaptive game controller 310. Accordingly, the mobile device 560 may be controlled through the adaptive game controller 310.

The adaptive game controller 310 may be operable to participate in a pairing process with mobile devices. For example, the adaptive game controller 310 may pair with the mobile device 560 and other mobile devices. Thereafter, the adaptive game controller 310 may remember the devices it has paired with and seamlessly connect with such devices in the future.

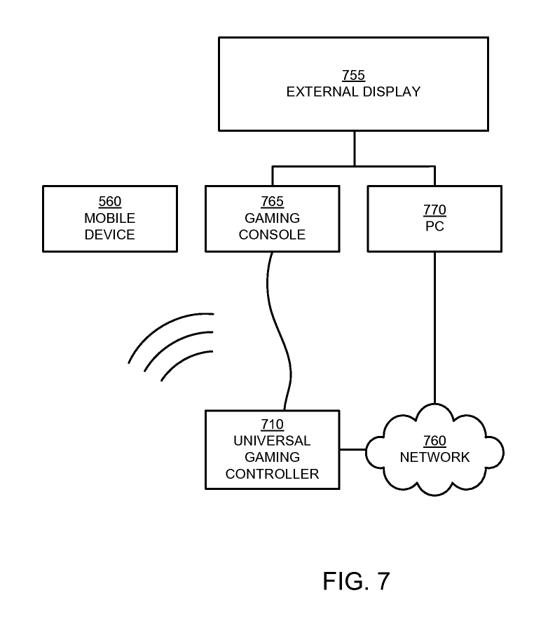

FIG. 6 is an illustration of an exemplary universal adaptive game controller 610 with a display 650, according to an embodiment of the present invention. The universal adaptive game controller 610 may be similar to the universal adaptive game controller 310 of FIGS. 3-5, however, the universal adaptive game controller 610 may include the display 650. The display 650 may be housed within or on the surface of a controller body 615. The display 650 may be a touchscreen display operable for physical interaction, for example, by a finger or a stylus.

The software application executed by the universal adaptive game controller 610 may be, for example, interactive media like a video game or any application operable to display video content, e.g. movies, web browser, etc. The software application may be coupled with a graphics system, which in turn may be coupled with the display 650. The graphics system may process data from the software application in order to generate pixel data for display as images or video, on for example, the display 650. For example, the software application may provide instructions, commands, and/or other data to the graphics system in order for the graphics system to generate an image intended for display or known by the software application.

Like the universal adaptive game controller 310, the universal adaptive game controller 610 may provide a user interface and receive commands therefrom. For example, the universal adaptive game controller 610 may include physically manipulatable controls, gyroscopic sensor, accelerometer sensor, environmental motion-tracking component, and so on. Accordingly, the software application may be controlled through these user interface components.

FIG. 7 is block diagram of an exemplary universal adaptive game controller 710 in communication with at least one device, according to an embodiment of the present invention. The universal adaptive game controller 710 may be the same as, or similar to, the universal adaptive game controller 310 or 610 of FIG. 3-5 or 6, respectively.

The universal adaptive game controller 710 may be operable to communicate with at least one device. The universal adaptive game controller 710 may pair with such devices and may provide instructions based on the manipulation of the universal adaptive game controller's 710 user interface.

In one embodiment, the universal adaptive game controller 710 may act as a video game controller for a game that is being executed on another device. For example, the universal adaptive game controller 710 may wirelessly communicate (as shown) with a mobile device 560 to provide user inputs to a game being executed on the mobile device 560. It should be appreciated that the universal adaptive game controller 710 may communicatively couple with devices, including the devices included in FIG. 7, through a wired or wireless interface. The mobile device 560 may be docked or secured on a device docking area of the universal adaptive game controller 710.

The universal adaptive game controller 710 may communicate with the mobile device 560 through software or an application on the mobile device 560. For example, an operating on the mobile device 560 may include an interface for communicating with the universal adaptive game controller 710. Alternatively, an application may provide the ability to communicate with the universal adaptive game controller 710. The application may be downloaded and installed from an external source, for example, an app store.

The function of each user interface control of the universal adaptive game controller 710 may be configured or customized. For example, a certain button that typically corresponds to a control instruction to the mobile device 560 may be configured to correspond to a second and different control instruction. In another example, a joystick's behavior may be set to be inverted. The button may be configured to correspond to the second control instruction for a specific software application, for all software applications of the mobile device 560 universally, or for all devices that the universal adaptive game controller 710 may connect with.

The universal adaptive game controller 710 may store the user interface configuration settings of the user interface controls for the specific software application, for all software applications of the mobile device 560 universally, or for all devices that the universal adaptive game controller 710 may connect with. Such information may be stored locally on the adaptive game controller 710, or remotely through a cloud-based computing system. Accordingly, the adaptive game controller 710 may save a user interface profile for each software application or device.

In addition, the universal adaptive game controller 710 may store information related to the state of the software application executing on the device it is communicatively coupled with or executing on the universal adaptive game controller 710 itself. For example, the information may include a user's progress through a game, e.g., a checkpoint in a map or a level. In another example, the information may include game statistics, like a health percentage or the amount of ammunition available to a user's character. In yet another example, the information may include a user's profile, so that when the universal adaptive game controller 710 is used, the user is automatically signed in to their profile.

Subsequently, the universal adaptive game controller 710 may communicatively couple with another device, for example, a gaming console 765. The gaming console 765 may be a conventional gaming console, e.g. Microsoft Xbox, Sony PlayStation, Nintendo Wii, and so on.

In another example, the universal adaptive game controller 710 may act as a video game controller for a game that is being executed on the gaming console 765. For example, the universal adaptive game controller 710 may communicate with the gaming console 765 through a wired interface (as shown) to provide user inputs to a game being executed on the gaming console 765.

The wired interface may include a cable that is operable to connect with a port, in some cases a proprietary interface, on the gaming console 765 manufactured to interface with a game controller that is intended to be used with the gaming console 765 by the manufacturer of the gaming console 765. Alternatively, the wired interface may include a cable that may connect with a standardized communication port, e.g., a USB port on the gaming console 765.

Again, it should be appreciated that the universal adaptive game controller 710 may communicatively couple with devices, including the devices included in FIG. 7, through a wired or wireless interface. For example, the universal adaptive game controller 710 may connect with the gaming console 765 through a Bluetooth or IEEE 802.11 interface when the gaming console 765 includes transceivers for such technologies, or is operable to use a peripheral add-on that provides such capabilities.

In one embodiment, the universal adaptive game controller 710 may simulate or mimic the communication protocol of a game controller that is intended to be used with the gaming console 765 by the manufacturer of the gaming console 765, e.g., a game controller that is shipped with the gaming console 765. Accordingly, the gaming console 765 may be unaware that it is communicating with a game controller other than the game controller that it was intended to work with.

In another embodiment, the universal adaptive game controller 710 may not simulate or mimic the communication protocol of a game controller that is intended to be used with the gaming console 765 by the manufacturer of the gaming console 765. For example, the gaming console 765 may be aware that it is communicating with a game controller other than the game controller that it was intended to work with.

As discussed above, the function of each user interface control of the universal adaptive game controller 710 may be configured or customized. Accordingly, the user interface controls may be configured to behave similarly to the configuration a user may have set for communication with the mobile device 560. For example, while the control for firing a weapon or causing a character to jump may be a touchscreen button on the mobile device 560, the same control on the game controller shipped with the gaming console 765 may be a physically depressible button. Importantly, the universal adaptive game controller 710 may map or bind one button to control the same firing of a weapon or jumping of a character on both the mobile device 560 and gaming console 765. Accordingly, a user may be provided a consistent user interface, improving gaming experience and avoiding time spent learning how to use different game controllers.

Alternatively, the user interface controls may be configured to behave differently from the configuration a user may have set for communication with the mobile device 560. For example, a user may prefer that a certain button on the universal adaptive game controller 710 may control the mobile device 560 in one way and control the gaming console 765 in another way.

As discussed above, the universal adaptive game controller 710 may store the user interface configuration settings of the user interface controls for the specific software application, for all software applications of the mobile device 560 universally, or for all devices that the universal adaptive game controller 710 may connect with. Accordingly, when the universal adaptive game controller 710 couples or pairs with a device, e.g. the mobile device 560 or gaming console 765, it may map the user interface controls based on the device it is coupled with.

Further, as discussed above, the universal adaptive game controller 710 may store information related to the state of the software application executing on the device it is communicatively coupled with or executing on the universal adaptive game controller 710 itself. For example, the user may have played a game on the mobile device 560, where the universal adaptive game controller 710 stored information related to a user's progress through a game, e.g., a checkpoint in a map or a level. Subsequently, when the universal adaptive game controller 710 couples with the gaming console 765 to play the same game, the universal adaptive game controller 710 may provide the information to the gaming console 765 so that the game resumes based on the progress of the user through the game.

In other examples, the game on the gaming console 765 may resume with, for example, game statistics like a health percentage or the amount of ammunition available to a user's character. In a further example, the universal adaptive game controller 710 may provide a user's profile to the gaming console 765, so that when the universal adaptive game controller 710 is used, the user is automatically signed in to their profile.

In some embodiments, the universal adaptive game controller 710 may act as a video game controller for a game that is being executed on the PC 770. For example, the universal adaptive game controller 710 may communicate with the PC 770 through a network 760 (as shown) to provide user inputs to a game being executed on the PC 770.

The PC 770 may be a desktop tower or a mobile computer. Further, the PC 770 may be operable to execute one or more operating systems, e.g., Microsoft Windows, Apple Mac OS X, Linux, and so on. The network 760 may be similar to the network 250 of FIG. 2 and may be a LAN or WAN. The network 760 may include wired connections, wireless connections, or a combination thereof. It should be appreciated that the universal adaptive game controller 710 may connect with any device through the network 760, for example, the mobile device 560 or the gaming console 765. Further, it should be appreciated that the universal adaptive game controller 710 may communicatively couple with the PC 770 through other interfaces, for example through a wired USB interface, Bluetooth, or IEEE 802.11.

Similarly with respect to the mobile device 560 or the gaming console 765, the universal adaptive game controller 710 may store user interface configurations specific for the PC 770. Accordingly, a user may play a game with customized controls for the PC 770, or a specific software application running on the PC 770.

Further, the universal adaptive game controller 710 may store other information related to a game running on the PC 770. For example, the universal adaptive game controller 710 may restore information related to the same game that was played on another device. Therefore, the PC 770 may resume game play of the game after the universal adaptive game controller 710 provides such information. Alternatively, information related to the game play on the PC 770 may be stored on the universal adaptive game controller 710 for future use with other devices.

It should be appreciated that when the universal adaptive game controller 710 is similar to the universal adaptive game controller 610 of FIG. 6, e.g. when the universal adaptive game controller 710 includes a display and may execute a software application, the universal adaptive game controller 710 may behave similarly as discussed above. For example, the universal adaptive game controller 710 may store user interface configurations for the universal adaptive game controller 710 itself. Further, the universal adaptive game controller 710 may store and restore information related to a software application so that a user may seamlessly continue interacting with another instance of the software application on a different device.

In various embodiments, the universal adaptive game controller 710 may be operable to communicate with an external display 755 through a wired or wireless interface. The display 755 may be any display, for example, a large display like a flat panel HDTV. The universal adaptive game controller 710 may, for example, be operable to control the audio volume, channel selection, input selection, menu screen, and so on. The user interface controls of the universal adaptive game controller 710 may be customized for the display 755.

It should be appreciated that the universal adaptive game controller 710 may provide low-latency communication with other devices. For example, a conventional television remote control does not provide fast communication. But because the universal adaptive game controller 710 may provide a user interface for real-time and fast-paced interactive media like video games, providing low-latency communication is desirable for user experience. For example, the universal adaptive game controller 710 may provide latency times less than 10 ms, less than 20 ms, or less than 30 ms.

In some embodiments, when the universal adaptive game controller 710 includes a display or is docked with the mobile device 560, a software application may be executed on a device like the gaming console 765 or the PC 770 and sending video, audio, and other data related to the software application back to the display or mobile device 560 for display. Meanwhile, the universal adaptive game controller 710 may provide the user interface to the software application.

FIG. 8 depicts a flowchart 800 of an exemplary process of using a universal adaptive game controller, according to an embodiment of the present invention. The invention, however, is not limited to the description provided by flowchart 800. Rather, it will be apparent to persons skilled in the relevant art(s) from the teachings provided herein that other functional flows are within the scope and spirit of the present invention. Flowchart 800 will be described with continued reference to exemplary embodiments described above, though the method is not limited to those embodiments.

In a block 802, a first user interface configuration is received from a plurality of user configurations, wherein said user interface configuration corresponds to a first interactive media device and a first instance of a software application. For example, in FIG. 7, the universal gaming controller 710 may receive a user interface configuration corresponding to a video game that executes on the mobile device 560. The user interface configuration may be, for example, information about which buttons or other controls on the mobile device 560 are mapped to which functions of the video game.

In a block 804, a software application state is received from a first interactive media device. For example, in FIG. 7, the universal gaming controller 710 may receive a software application state corresponding to a video game that executes on the mobile device 560. The software application state may be, for example, information about the progress of a user through the video game, including progress to checkpoints or a user profile.

In a block 806, the user interface configuration is stored. For example, the user interface configuration may be stored on the universal gaming controller 710 or on a cloud-based system.

In a block 808, the software application state is stored. For example, the software application state may be stored on the universal gaming controller 710 or on a cloud-based system.

In a block 810, upon communicatively coupling with a second interactive media device, a user interface is reconfigured from a second user interface configuration based on said first user interface configuration corresponding to said first interactive media device and said first instance of said software application. For example, the universal gaming controller 710 may communicatively couple with the gaming console 765, whereupon the buttons or other controls of the universal gaming controller 710 may be mapped or configured based on the control configuration for the mobile device 560.

In a block 812, upon communicatively coupling with the second interactive media device, the software application state is sent to the second interactive media device for restoring an instance of the software application executing on the second interactive media device to a restored state corresponding to the software application state. For example, the universal gaming controller 710 may communicatively couple with the gaming console 765, whereupon the universal gaming controller 710 may send the software application state to the mobile device 560. For example, the video game executing on the gaming console 765 may be restored or set to a game state based on the checkpoint progress or the user profile.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. An apparatus comprising:
a body comprising a user interface, wherein said user interface is operable to be configured for a first interactive media device and a second interactive media device;
memory operable to store a plurality of user interface configurations, wherein a first user interface configuration corresponds to said first interactive media device and said second interactive media device, and wherein said memory is further operable to store a software application state; and
a communication interface operable to communicatively couple with said first interactive media device and said second interactive media device, wherein said communication interface is operable to send user inputs from said user interface to said first interactive media device and said second interactive media device.

2. The apparatus of claim 1, wherein said communication interface is operable to communicate with said first interactive media device and said second interactive media device with a communication latency of less than 20 ms.

3. The apparatus of claim 1, wherein said body further comprises a docking area operable to secure an interactive media device, wherein said docking area is adjustable to accommodate interactive media devices of varying dimensions.

4. The apparatus of claim 1, wherein said body is operable to inductively charge interactive media devices.

5. The apparatus of claim 1, wherein said user interface further comprises at least one button and at least one directional pad.

6. The apparatus of claim 1, further comprising a processor operable to execute a software application, wherein said user interface is operable to control said software application and wherein said body further comprises a display operable to display video rendered in response to instructions from said software application.

7. The apparatus of claim 1, wherein said at least one interactive media device is a mobile electronic device, gaming console, or computer system.

8. A method comprising:
receiving a first user interface configuration from a plurality of user configurations, wherein said user interface configuration corresponds to a first interactive media device and a first instance of a software application;
storing said user interface configuration; and
upon communicatively coupling with a second interactive media device, reconfiguring a user interface from a second user interface configuration based on said first user interface configuration corresponding to said first interactive media device and said first instance of said software application.

9. The method of claim 8, wherein said communicatively coupling with said second interactive media device is achieved through wireless communication.

10. The method of claim 8, wherein said storing comprises storing said user interface on a cloud-based computing system.

11. The method of claim 8, wherein said second interactive media device is the said first interactive media device.

12. The method of claim 8, further comprising sending user inputs at said user interface to said second interactive media device.

13. The method of claim 12, wherein said reconfiguring causes a second instance of said software application executing on said second interactive media device to respond to said sending similarly as said first instance of said software application.

14. The method of claim 12, wherein said sending comprises a communication latency of less than 20 ms.

15. A method comprising:
receiving first a software application state from a first interactive media device;
storing said software application state; and
upon communicatively coupling with a second interactive media device, sending said software application state to said second interactive media device for restoring an instance of said software application executing on said second interactive media device to a restored state corresponding to said software application state.

16. The method of claim 15, wherein said communicatively coupling with said second interactive media device is achieved through wireless communication.

17. The method of claim 15, wherein said storing comprises storing said software application state on a cloud-based computing system.

18. The method of claim 15, wherein said second interactive media device is the said first interactive media device.

19. The method of claim 15, wherein said software application state comprises information about a user's progress in a video game.

20. The method of claim 15, wherein said sending comprises a communication latency of less than 20 ms.
